(19) United States
(12) Patent Application Publication
(10) Pub. No.: US 2005/0285814 A1
(43) Pub. Date: Dec. 29, 2005

(54) Electroluminescent display

(75) Inventors: Roelf Van Der Wal, Eindhoven (NL); Willibrordus Jurrianus Dijkman, Eindhoven (NL); Josephus Adrianus Maria Erp, Eindhoven (NL); Klaas Jacob Lulofs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/524,402

(22) PCT Filed: Jul. 17, 2003
(86) PCT No.: PCT/IB03/03264

§ 371 Date: Feb. 11, 2005

(30) Foreign Application Priority Data
Aug. 12, 2002 (EP) 02078319.7

(51) Int. Cl. G09G 3/14

(52) U.S. Cl. 345/46

(57) ABSTRACT

A driver circuit drives an electroluminescent display (1) which comprises a matrix of display pixels (10) associated with intersections of data electrodes (12) and select electrodes (11). The driver circuit comprises a select driver (2) which supplies a select signal (VS) comprising non-overlapping select pulses (VSP) with a predetermined repetition frequency to a selected one (11′) of the select electrodes (11). The data driver (3) supplies data signals (DS) comprising data pulses (DSP) with the same predetermined repetition frequency to the data electrodes (12). The data pulses (DSP) occur during the select pulses (VSP) for data electrodes (12) of which associated pixels (10) should not produce light. The data pulses (DSP) occur in-between the select pulses (VSP) for data electrodes (12) of which associated pixels (10) should produce light.

The invention relates to a driver circuit for driving an electroluminescent display, a display apparatus comprising such a driver circuit, and a method of driving an electroluminescent display.

U.S. Pat. No. 6,072,619 discloses an electroluminescent display which includes a first set of fibers and a second set of fibers which are arranged to form a two dimensional array of junctions between fibers of the first set of fibers and fibers of the second set of fibers. Each of the fibers of the first and second sets of fibers includes a longitudinal conductive element, whereas fibers of at least one of the first and the second sets of fibers, at least at the junctions, further include a coat of an electro-optically active substance which is capable of reversibly changing its optical behavior when subjected to an electric or a magnetic flux or field. The light modulating device is flexible and foldable. This electroluminescent display is further referred to as woven EL display.

US-B-6,249,279 discloses a row drive circuit for an AC-thin-film electroluminescent display which generates the drive signals with a resonant energy recovery circuit to lower the dissipation caused by the charging and discharging of the pixels. In AC-thin-film electroluminescent displays, the amount of light produced by a pixel depends on the value of the data voltage of the data drive signals on the data electrode. The data drive signal is applied to a particular pixel once in a frame. The AC-thin-film electroluminescent display is further referred to as ACTFEL display

If the known drive scheme for the ACTFEL display is applied on the woven EL display the light output is very low.

It is an object of the invention to increase the light output of an EL display.

A first aspect of the invention provides a driver circuit for driving an electroluminescent display as claimed in claim 1. A second aspect of the invention provides a display apparatus comprising such a driver circuit as claimed in claim 7. A third aspect of the invention provides a method of driving an electroluminescent display as claimed in claim 8. Advantageous embodiments are defined in the dependent claims.

A driver circuit drives the electroluminescent display which comprises a matrix of display pixels which are associated with intersections of data electrodes and select electrodes.

A select driver supplies a select signal comprising select pulses with a predetermined repetition frequency to a selected row during a select period.

A data driver supplies data signals to the data electrodes. The data signals comprise data pulses with the same predetermined repetition frequency. The data pulses occur during the select pulses, or said differently, have the same phase as the select pulses for data electrodes of which associated pixels should not produce light. The data pulses occur in-between the select pulses, or said differently, have the opposite phase as the select pulses (or are substantially 180 degrees shifted in phase with respect to the select pulses) for data electrodes of which associated pixels should produce light.

To facilitate an easy elucidation of the invention, by way of example, the select electrodes which, for a woven EL display, consist of the conductive elements of the first set of fibers, are referred to as the row electrodes as they usually extend in the horizontal direction. And, the data electrodes of the woven EL display which consist of the conductive elements of the second set of fibers are referred to as the column electrodes as they usually extend in the vertical direction.

The rows are scanned using the line-at-a-time method. A select signal which comprises non-overlapping select pulses which have a particular repetition frequency is supplied to the selected row, while the other rows are connected to ground. If a particular pixel of the selected row should not produce light (should be “Off”) the respective column is driven with an address signal which comprises address pulses with the same particular repetition frequency as the select pulses and which occur during the occurrence of the select pulses. If a particular pixel should produce light (should be “On”), the respective column is driven with an address signal which comprises address pulses with the same repetition frequency as the select pulses and which occur in-between the select pulses. Said in different words, the address pulses are out- or in-phase with the row voltage for a “On” and a “Off” pixel, respectively.

Hence, for the “Off” pixels, the differential voltage is the amplitude of the select pulses minus the amplitude of the address pulses because the select pulses are in phase with the address pulses. The value of the differential voltage across the pixel is too low for the pixel to produce light. For the “On” pixels, the differential voltage is the amplitude of the select pulses added to the amplitude of the address pulses because both pulses have opposite phase. The peak-peak value of the differential voltage across the pixel is large enough for the pixel to produce light.

For example, if the amplitude of the select pulses is twice as high as the amplitude of the address pulses, the voltage across “Off” pixels is a factor three lower than the voltage across the “On” pixels.

The pulses across the pixels are present during substantially the select period during which a row is selected to receive the address signals. An “On” pixel will ignite several times during the select period. Consequently, the light output obtained by the driving circuit in accordance with the invention is higher than the light output obtained by the known driving circuit for the ACTFEL display.

It is desirable to produce a lot of ignitions during the select period to produce a suitable amount of light. Thus, usually, the repetition frequency of the pulses of both the select and the data pulses is high.

The invention is useful for increasing the light output of all EL displays, but is particular useful for driving an EL display that has a relatively low light output such as the woven EL display.

Since the rows that are not selected are grounded, the pixel voltage applied to not selected pixels is equal to the column voltage. Consequently, these “Off” pixels all receive address pulses with the same amplitude which is too low to cause the pixels to produce light, these “Off” pixels have the repetition frequency of the select pulses but are phase shifted over 180 degrees with respect to each other depending on whether the associated pixel in the selected row should be on or off.

In an embodiment in accordance with the invention as defined in claim 2, the energy recovery circuit supplies output pulses with sine-wave shaped edges and a repetition frequency which is twice the repetition frequency of the select pulses. Thus the output pulses occur both during a select pulse and in-between two successive select pulses. The data driver comprises means for directing either the output pulses which have the same phase (occur during a select pulse) or the output pulses which have the opposite phase (occur in-between two successive select pulses) to the data electrodes. Thus, depending on whether a pixel has to produce light, a pulse train of output pulses is selected which have the same phase as the select pulses, or a pulse train of output pulses is selected which have the opposite phase as the select pulses.

By selecting the required output pulses from the pulses generated by the energy recovery circuit, only a single energy recovery circuit is required although two different signals are produced.

In an embodiment in accordance with the invention as defined in claim 4, existing integrated circuits suitable for plasma display panel driving can be used.

In an embodiment in accordance with the invention as defined in claim 6, the edges of the select pulses supplied to the select electrodes, and the edges of the output pulses supplied to the data electrodes become more equal. This prevents that pixels erroneously produce light due to too different rise and fall times of these edges.

These and other aspects of the invention are apparent from and will be elucidated with reference to the embodiments described hereinafter.

In the drawings:

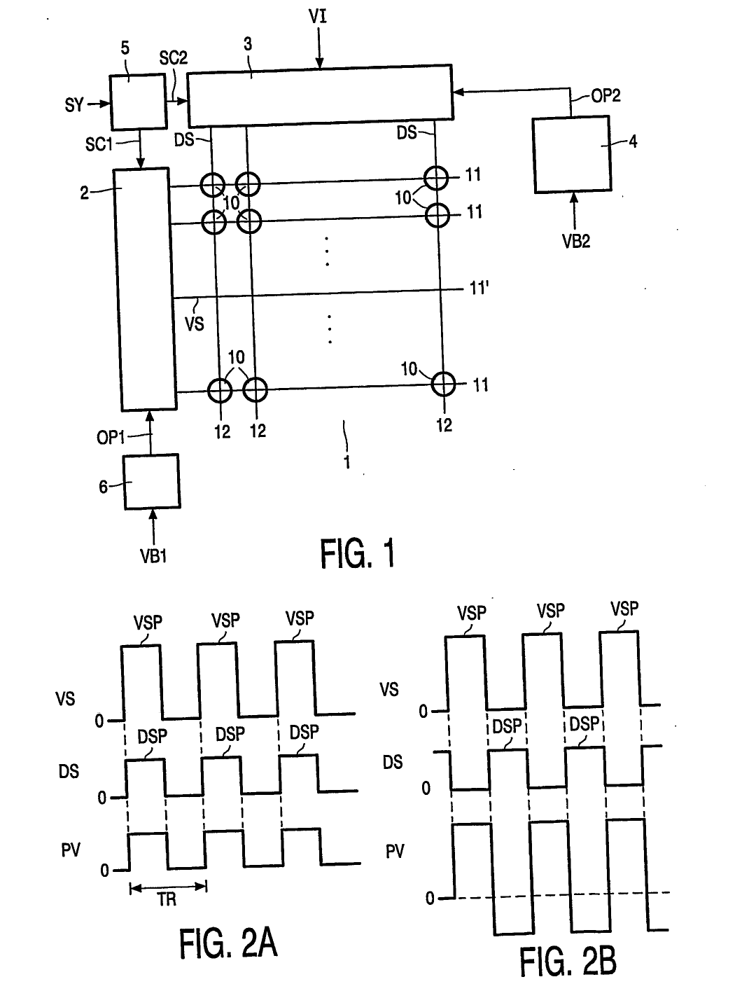

FIG. 1 shows a block diagram of a display apparatus with an electroluminescent display,

FIG. 2 show waveforms for elucidating the basic operation of the display apparatus,

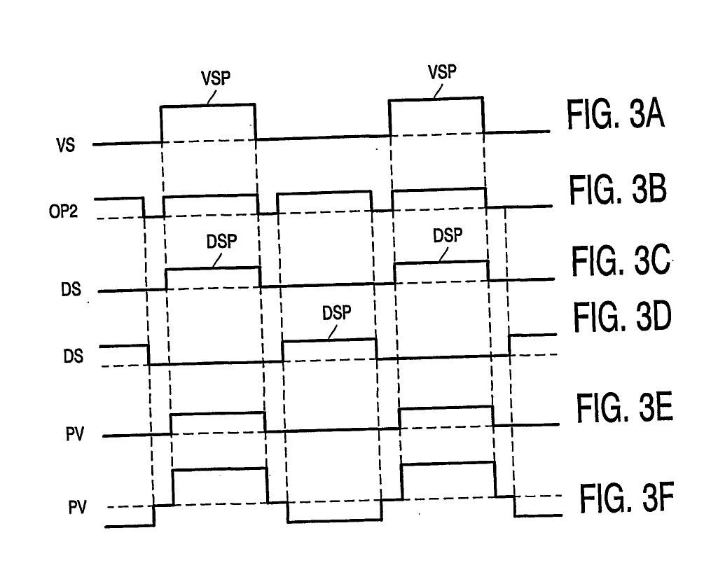

FIG. 3 show waveforms for elucidating the operation of the display apparatus in accordance with an embodiment of the invention,

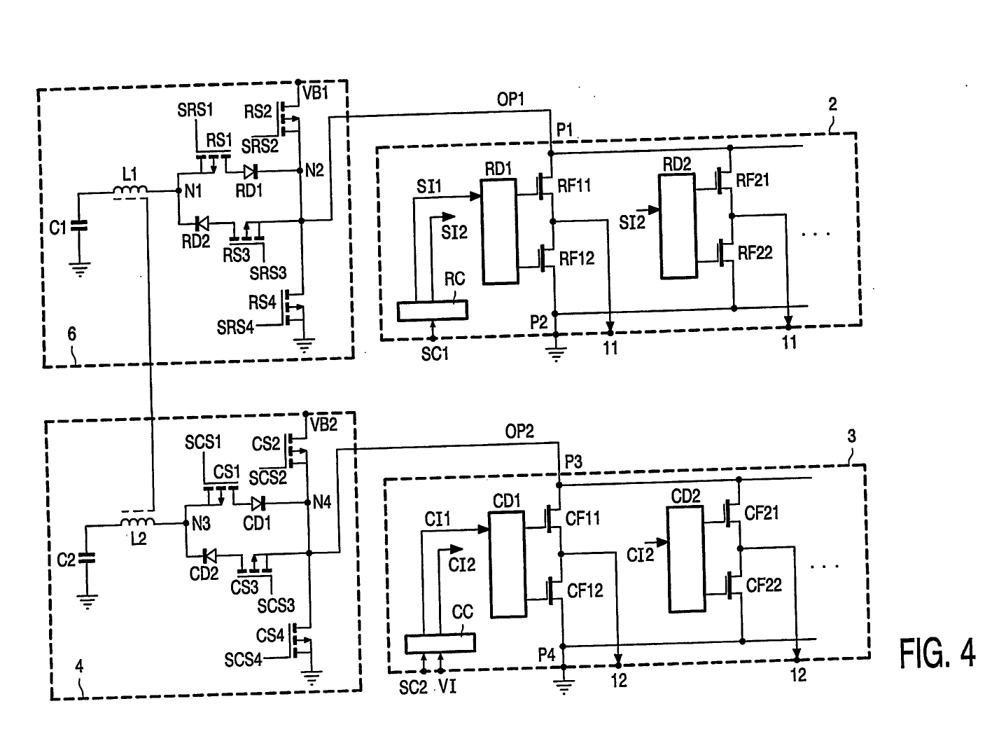

FIG. 4 shows an embodiment of a select driver and its associated energy recovery circuit, and a data driver and its associated energy recovery circuit in accordance with the invention,

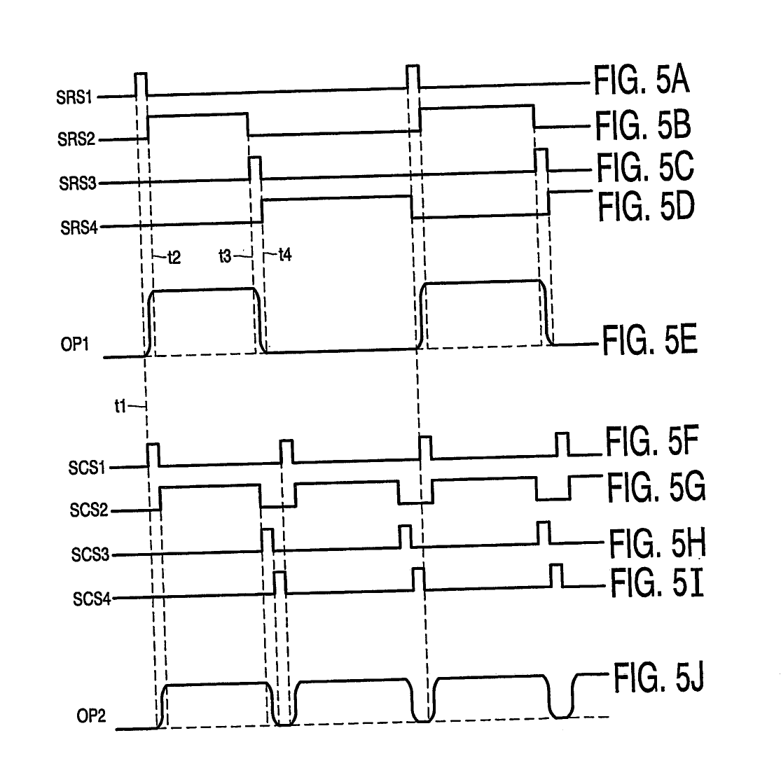

FIG. 5 shows waveforms elucidating the operation of the energy recovery circuits,

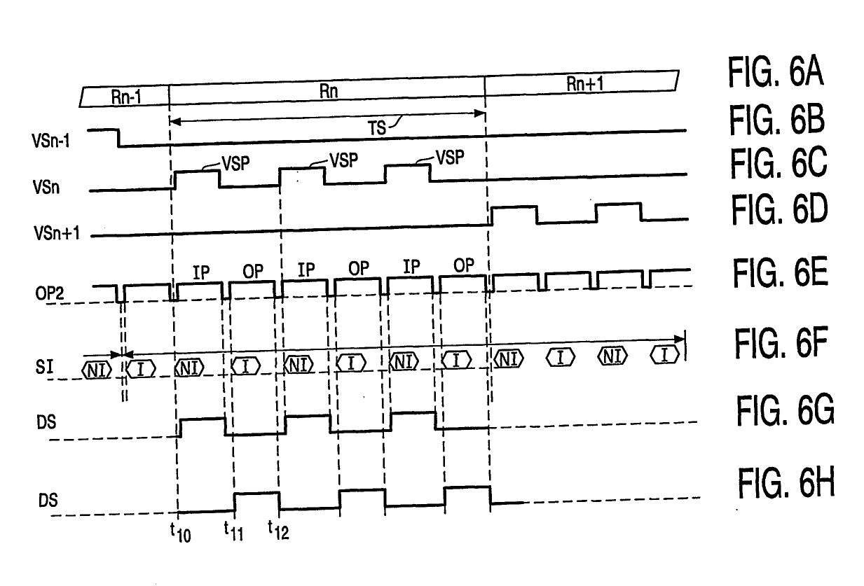

FIG. 6 show further waveforms elucidating the operation of the select and data driver, and

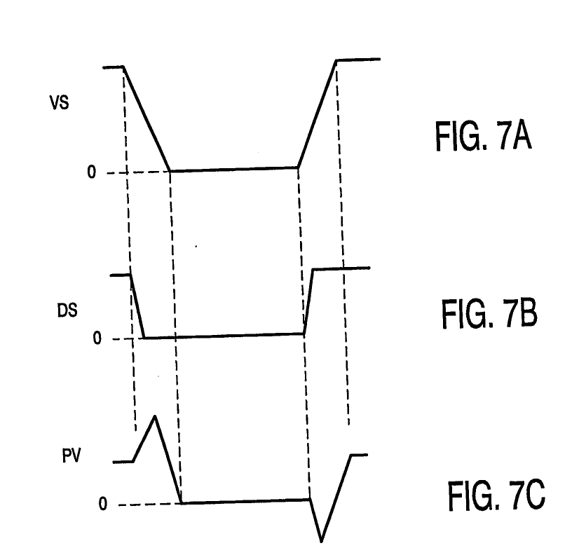

FIG. 7 show waveforms elucidating undesired effects if the rise and fall times of the select pulses and data pulses differ too much.

The same references in different Figs. refer to the same signals, or to the same elements performing the same function.

FIG. 1 shows a block diagram of a display apparatus with an electroluminescent display 1.

The electroluminescent display 1 comprises a matrix of display pixels 10 which are associated with intersections of data electrodes 11 and select electrodes 12.

A select driver 2 supplies a select signal VS comprising select pulses VSP (see FIG. 2) with a predetermined repetition frequency 1/TR (or repetition period TR) to a selected row 11′ during a select period TS (see FIG. 6). Usually, the select period TS is the line period of the video signal VI supplied to the data driver 3.

The data driver 3 supplies data signals DS to the data electrodes 12. The data signals DS comprise data pulses DSP (see FIG. 2) with the same predetermined repetition period TR. The data pulses DSP have the same phase as (occur during) the select pulses VSP for data electrodes 12 of which associated pixels 10 should not produce light. The data pulses DSP have the opposite phase as (occur in-between) the select pulses VSP for data electrodes 12 of which associated pixels 10 should produce light.

An optional select energy recovery circuit 6 receives a DC power supply voltage VB1 and supplies output pulses OP1 with sine-wave shaped edges and a repetition frequency equal to the repetition frequency 1/TR of the select pulses VSP to the select driver 2. The optional data energy recovery circuit 4 receives a DC power supply voltage VB2 and supplies output pulses OP2 with sine-wave shaped edges to the data driver 3.

The controller 5 receives timing information SY and supplies control signals SC1 and SC2 to the select driver 2 and the data driver 3, respectively. Usually, the timing information SY comprises the horizontal and vertical synchronization signals belonging to the video signal VI.

The operation of the electroluminescent display 1 is elucidated with respect to FIG. 2 for an EL display 1 without using the data and select energy recovery circuits 4 and 6, respectively. The operation of the EL display 1 is elucidated with respect to FIG. 3 for a drive scheme in accordance with an embodiment of the invention using the select energy recovery circuit 6.

FIG. 2 show waveforms for elucidating the basic operation of the display apparatus.

FIG. 2A shows, for an “Off” pixel 10, from top to bottom, the select signal VS on the selected select electrode 11′, the data signal DS on a data electrode 12 of which the associated pixel 10 should be off, and the pixel voltage PV across this pixel 10. As becomes clear from FIG. 2A, for the “Off” pixels 10 which should not produce light, the pixel voltage PV is the amplitude of the select pulses VSP minus the amplitude of the data pulses DSP because the select pulses VSP occur during the data pulses DSP. The value of the differential voltage PV across the pixel 10 is too low to produce light.

FIG. 2B shows, for an “On” pixel 10, from top to bottom, the select signal VS on the selected select electrode 11′, the data signal DS on a data electrode 12 of which the associated pixel 10 should be on, and the pixel voltage PV across this pixel 10.

For the “On” pixels which should produce light, the pixel voltage PV is the amplitude of the select pulses VSP added to the amplitude of the data pulses DSP because the data pulses DSP occur in-between the select pulses VSP. The peak-peak value of the pixel voltage PV across the pixel is large enough to produce light.

FIG. 3 show waveforms for elucidating the operation of the display apparatus in accordance with an embodiment of the invention.

FIG. 3A shows the select voltage VS and its select pulses VSP on the selected select electrode 11′. This signal may be generated to have sine wave shaped edges by using the select energy recovery circuit 6, but this is not essential to the invention.

FIG. 3B shows the output pulses OP2 supplied to the data driver 3, preferably by the data energy recovery circuit 4. The output pulses OP2 have sine-wave shaped edges (not shown in FIG. 3B) and a repetition frequency which is twice the repetition frequency of the select pulses VSP. Thus the output pulses OP2 occur during a select pulse VSP and in-between two successive select pulses VSP. The data driver 3 directs either the output pulses OP2 which have the same phase (occur during a select pulse VSP) or the output pulses OP2 which have the opposite phase (occur in-between two successive select pulses VSP) to the data electrodes 12. Thus, depending on whether a pixel 10 has to produce light, the data signal DS comprises a pulse train of output pulses OP2 which is selected to have the same phase as the select pulses VSP, see FIG. 3C, or the data signal DS comprises a pulse train of output pulses OP2 which is selected to have the opposite phase as the select pulses VSP, see FIG. 3D.

FIG. 3E shows the repetitive pixel voltage PV with a low amplitude across the pixels 10 which should be off, and FIG. 3F shows the repetitive pixel voltage PV with a high amplitude across the pixels 10 which should be on.

The select energy recovery circuit 6 and the data energy recovery circuit 4 are not essential to the invention, it suffices to generate the select pulses VSP of FIG. 3A and the data pulses of FIG. 3C or 3D. For example, the data pulses DSP may be generated by the data driver 3 by appropriately controlling the push-pull output stages, and without the use of the data energy recovery circuit 4.

FIG. 4 shows an embodiment of a select driver and its associated energy recovery circuit and a data driver and its associated energy recovery circuit, in accordance with the invention.

The select driver 2 comprises a plurality of push-pull output stages. In FIG. 4 only two output stages are shown. In a practical implementation much more output stages may be required, at least one for every select electrode 11. Each output stage comprises a series arrangement of two switches: RF11 and RF12, RF21 and RF22. All the output stages are arranged between the nodes P1 and P2. The respective junctions of the two switches RF11 and RF12, RF21 and RF22 are coupled to respective select electrodes 11. The node P1 receives the output pulses OP1 from the energy recovery circuit 6. The node P2 is connected to ground. Each one of the output stages is driven by an output stage drive circuit RD1, RD2. A select driver controller RC receives the control signal SC1 from the controller 5 to supply the control signals S11 and S12 to the output stage drive circuits RD1, RD2, respectively. The control signal SC1 causes the control signals SI1, SI2, . . . to have values which via the output stage drive circuits RD1, RD2, . . . , respectively, control the switches RFi1, RFi2 such that for a selected select electrode 11′ the switch RFi1 is conductive and the switch RFi2 is non-conductive, while for a not selected select electrode 11 the switch RFi2 is conductive and the switch RFi1 is non-conductive. Usually, the output stage drive circuits RD1, RD2 . . . comprise push-pull stages.

Also the data driver 3 comprises a plurality of push-pull output stages. In FIG. 4 only two output stages are shown. In a practical implementation much more output stages may be required, usually at least one for every data electrode 12. Each output stage comprises a series arrangement of two switches CF11 and CF12, CF21 and CF22. All the output stages are arranged between the nodes P3 and P4. The respective junctions of the two switches CF11 and CF12, CF21 and CF22 are coupled to respective data electrodes 12. The node P3 receives the output pulses OP2 from the energy recovery circuit 4. The node P4 is connected to ground. Each one of the output stages is driven by an output stage drive circuit CD1, CD2. A select driver controller CC receives the control signal SC2 from the controller 5 and the input data VI to supply the control signals CI1 and CI2 to the output stage drive circuits CD1, CD2, respectively. The control signals CI1, CI2, . . . control the output stage drive circuits CD1, CD2, . . . such that switches CFij, depending on whether pixels 10 associated with the elected select electrode 11′ should produce light or not. The conductive and non-conductive phases of the switches CFij are explained with respect to FIGS. 5 and 6.

The energy recovery circuit 6 comprises a series arrangement of a capacitor C1 and a resonance inductor L1, the series arrangement is arranged between the node N1 and ground. A series arrangement of a switch RS1 and a diode RD1 is arranged between the node N1 and the node N2. The cathode of the diode RD1 is directed towards the node N2. A series arrangement of a switch RS3 and a diode RD2 is arranged between the node N1 and the node N2. The cathode of the diode RD2 is directed towards the node N1. A switch RS2 is arranged between the DC power supply voltage VB1 and the node N2. A switch RS4 is arranged between the node N2 and ground. The output pulses OP1 are available at the node N2. The control inputs of the switches RS1, RS2, RS3, RS4 receive the switching signals SRS1, SRS2, SRS3, SRS4, respectively.

The energy recovery circuit 4 comprises a series arrangement of a capacitor C2 and a resonance inductor L2, the series arrangement is arranged between the node N3 and ground. A series arrangement of a switch CS1 and a diode CD1 is arranged between the node N3 and the node N4. The cathode of the diode CD1 is directed towards the node N4. A series arrangement of a switch CS3 and a diode CD2 is arranged between the node N3 and the node N4. The cathode of the diode CD2 is directed towards the node N3. A switch CS2 is arranged between the DC power supply voltage VB2 and the node N4. A switch CS4 is arranged between the node N4 and ground. The output pulses OP2 are available at the node N4. The control inputs of the switches CS1, CS2, CS3, CS4 receive the switching signals SCS1, SCS2, SCS3, SCS4, respectively.

The resonance inductors L1 and L2 may be magnetically coupled to improve the similarity of the output pulses OP1 and OP2. Although not shown, it is also possible to use a capacitive coupling instead of the magnetically coupling to obtain edges of the output pulses OP1 and OP2 which are as similar as possible.

Although the switches shown in FIG. 4 are preferably FET's, any other electronic switches are suitable, such as bipolar transistors.

The operation of the circuits shown in FIG. 4 will be elucidated with respect to FIGS. 5 and 6.

FIG. 5 shows waveforms elucidating the operation of the select energy recovery circuit 6. FIGS. 5A, 5B, 5C and 5D show the switching signals SRS1, SRS2, SRS3 and SRS4 supplied to the control inputs of the switches RS1, RS2, RS3 and RS4, respectively. FIG. 5E shows the output pulses OP1 supplied to the select driver 2. FIGS. 5F, 5G, 5H and 5I show the switching signals SCS1, SCS2, SCS3 and SCS4 supplied to the control inputs of the switches CS1, CS2, CS3 and CS4, respectively. FIG. 53 shows the output pulses OP2 supplied to the data driver 3.

The purpose of the data and select energy recovery circuits 4 and 6, respectively, is to charge and to discharge the pixel capacitance of the pixels 10 with low power consumption.

The operation of the select energy recovery circuit 6 is elucidated in detail only, the data energy recovery circuit 4 operates in exactly the same way. The only difference is that all the switching signals SCS1, SCS2, SCS3 and SCS4 have twice the repetition frequency of the switching signals SRS1, SRS2, SRS3 and SRS4. Consequently, the repetition frequency of the output pulses OP2 is twice that of the output pulses OP1.

In the initial state of the select energy recovery circuit 6, the capacitor C1 is charged to half the power supply voltage VB1, and the voltage PV across the pixel 10 is zero.

When at the instant t1 the switch RS1 is closed the pixel capacitance present at the selected one 11′ of the select electrodes 11 will be charged via the coil L1. The coil L1 together with the pixel capacitance forms a resonant circuit, the current through the coil L1 will be sinusoidal, and thus the voltage on the selected select electrode 11′ will change sinusoidal. The selected select electrode 11′ is the select electrode 11 for which the upper switch RFi1 of the select driver 2 is conductive while all other upper switches RFi1 are non conductive. At the same time all the lower switches RFk2 connect the non-selected select electrodes to ground. Only the lower switch RFi2 which corresponds to the selected select electrode 11′ is non-conductive. During the time the selected select electrode 11′ is selected, the data driver 3 supplies the data signals DS to the electrodes 12 to obtain the desired pixel voltages PV across the pixel capacitances of the pixels 10 associated with the selected select electrode 11′ and consequently, the pixel voltages PV will rise sinusoidal.

At the instant t2 when the current through the coil L1 becomes negative the diode RD 1 will reverse bias and block the current. Ideally, without losses, the select voltage VS on the select electrode 11 is now equal to VB1. Then, the switch RS1 is opened and the switch RS2 is closed connecting the select electrode 11 to the power supply voltage VB1.

At the instant t3, the switch RS2 is opened and the switch RS3 is closed. The pixel capacitance is now discharged via the coil L1 and the switch RS3. The coil L1 together with the pixel capacitance forms a resonant circuit, the current through the coil L1 will be sinusoidal, and together with the appropriate voltages on the data electrodes 12, the voltages PV across the pixel capacitances will fail sinusoidal.

At the instant t4 when the current through the coil L1 becomes negative the diode RD2 will reverse bias and block the current. Ideally, without losses, the voltage VS on the select electrode 11 is now equal to ground. Then, the switch RS3 is opened and the switch RS4 is closed connecting the select electrode 11 to ground. The pulse in the output signal OP1 has ended.

Any other energy recovery circuit may be used It is also possible that both the output pulses OP1 and OP2 have the same highest repetition frequency and that the select driver 2 is controlled to use only half of the output pulses OP1 such that the result is that the repetition frequency of the data pulses DS at the data electrodes 12 is equal that of the select pulses VS at the selected one 11′ of the select electrodes 11.

FIG. 6 show further waveforms elucidating the operation of the select and data driver. FIG. 6A shows the row or line periods Rn−1, Rn, Rn+1 during which a select electrode 11 is selected and video information VI is displayed by supplying the correct data signals DS to the data electrodes 12. FIGS. 6B, 6C, and 6D show the select signals VSn−1, VSn and VSn+1 of three consecutive select electrodes 11. FIG. 6E shows the output pulses OP2 supplied by the energy recovery circuit 4 to the data driver 3. FIG. 6F shows the set SI of control signals CI1, CI2, . . . which determine the data pulses DSP on the data electrodes 12. FIGS. 6G and 6H show the data signals DS for data electrodes 12 of which the associated pixels 10 should be off or on, respectively.

The operation of the select driver 2 and data driver 3 is elucidated for the row Rn which starts at the instant t10. By way of example, the select signal VSn shows three select pulses VSP. In practice this number may be much higher. The output pulses OP2 have a repetition frequency which is twice the repetition frequency of the select pulses VSP.

The data driver 3 receives the output pulse OP2 and selects the pulses IP which are in phase with (or occur during) the select pulses VSP or the pulses OP which are out of phase with (or occur in-between) the select pulses VSP. This selection process is controlled with the set of control signals CI1, CI2, . . . which are alternatingly supplied in a non-inverted NM and an inverted I form.

For example, it is assumed that, of the output stages of the data driver 3, the upper switches CF11, CF21, . . . are closed and the lower switches CF12, CF22, . . . are open if the control signals CI1, CI2, . . . have the logical value 1. The upper switches CF11, CF21, . . . are open and the lower switches CF12, CF22, . . . are closed if the control signals CI1, CI2, . . . have the logical value 0. Further, it is assumed that of four successive pixels 10 associated with four successive data electrodes 12, the first two pixels 10 should not produce light, and the last two pixels 10 should produce light. Thus, the control signals CI1, CI2, . . . have the logical values 1 1 0 0, respectively for the non-inverted data periods I of the set SL and the control signals CI1, CI2, . . . have the logical values 0 0 1 1, respectively for the inverted data periods I of the set SI.

When, in this example, in the period of time from the instants t10 to t11, the non-inverted set N1 is supplied, due to the logical ones, the first two data electrodes 12 of the four successive data electrodes 12 are connected to receive the output pulses OP2. And due to the logical zeros, the last two data electrodes 12 of the four successive data electrodes 12 are connected to ground. When in the period of time from the instants t11 to t12, the inverted set I is supplied, due to the logical zeros, the first two data electrodes 12 of the four successive data electrodes 12 are connected to ground. And, due to the logical ones, the last two data electrodes 12 of the four successive data electrodes 12 are connected to receive the output pulses OP2. Consequently, the data signal DS comprises data pulses DSP in phase with the select pulses VSP for pixels which should not produce light, see FIG. 6G, and the data signal DS comprises data pulses DSP out of phase with the select pulses VSP for pixels which should not produce light, see FIG. 6H.

FIG. 7 show waveforms elucidating undesired effects if the rise and fall times of the select pulses and data pulses differ too much. FIG. 7A shows the select signal VS. FIG. 7B shows the data signal DS which has a lower amplitude and steeper edges than the select signal VS. FIG. 7C shows the pixel voltage PV which is the select signal VS minus the data signal DS. As becomes clear from FIG. 7C, the different rise and fall times of the edges causes an overshoot and undershoot which may be so large that a pixel 10 which should not produce light (the select pulses VSP and the data pulses DSP are in phase) will produce light.

To prevent a too large difference in rise and fall times of the edges of the select pulses VSP and the data pulses DSP in an embodiment of the invention, the inductors L1 and L2 of the select and the data energy recovery circuits 6 and 4, respectively, are magnetically coupled as shown in FIG. 4.

In a practical experimental implementation of a woven display EL panel I with 12 rows and 96 columns, the select pulses VSP have an amplitude which typically is within the range 260 to 300 volts, the data pulses DSP have an amplitude typically in the range of 120 to 150 volts, the repetition frequency of the select pulses VSP is typically in the range of 1 to 15 kHz with a duty cycle of typically 50%. The rise and fall times of the data pulses DSP and the select pulses VSP are typically in a range of 0.5 to 3 microseconds.

The inductors L1 and L2 of the energy recovery circuits 6 and 4 respectively which are magnetically coupled, may be windings of a transformer. The ratio of turns of the windings is preferably substantially equal to the ratio of the amplitude of the select pulses VSP and the amplitude of the data pulses DSP.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A driver circuit for driving an electroluminescent display comprising a matrix of display pixels being associated with intersections of data electrodes and select electrodes, the driver circuit comprises:
a select driver for supplying a select signal comprising non-overlapping select pulses with a predetermined repetition frequency to a selected one of the select electrodes during a select period,
a data driver for supplying data signals to the data electrodes, the data signals comprising data pulses with the same predetermined repetition frequency, the data pulses occurring during the select pulses for data electrodes of which associated pixels should not produce light, the data pulses occurring in-between the select pulses for data electrodes of which associated pixels should produce light.

2. A driver circuit as claimed in claim 1, characterized in that the driver circuit further comprises an energy recovery circuit for supplying output pulses with sine-wave shaped edges and a repetition frequency which is twice the predetermined repetition frequency, wherein the data driver comprises means for directing either the output pulses which occur during the select pulses, or the output pulses which occur in-between the select pulses to the data electrodes.

3. A driver circuit as claimed in claim 2, characterized in that the means for directing comprises push-pull output stages for receiving the output pulses across series arranged first and second electronic switches, junctions of the respective first and the second electronic switches being coupled to respective ones of the data electrodes, the driver circuit further comprising a controller for controlling the push-pull output stages to supply the output pulses to the data electrodes during the select pulses if the associated pixels should not produce light, or to supply the output pulses to the data electrodes in-between the select pulses if the associated pixels should produce light.

4. A driver circuit as claimed in claim 2, characterized in that at least a subset of the push pull output stages of the data driver is integrated in an integrated circuit, all the series arranged first and second electronic switches being coupled between terminals of the integrated circuit.

5. A driver circuit as claimed in claim 2, characterized in that the driver circuit comprises a further energy recovery circuit for generating the select pulses of the select signal with substantially sine-wave shaped edges.

6. A driver circuit as claimed in claim 5, characterized in that a resonance inductor of the first mentioned energy recovery circuit and a resonance inductor of the further energy recovery circuit are magnetically coupled.

7. A display apparatus comprising a driver circuit as claimed in claim 1.

8. A method of driving an electroluminescent display comprising a matrix of display pixels being associated with intersections of data electrodes and select electrodes, the method comprises:
supplying a select signal comprising non-overlapping select pulses with a predetermined repetition frequency to a selected one of the select electrodes during a select period,
supplying data signals to the data electrodes, the data signals comprising data pulses with the same predetermined repetition frequency, the data pulses occurring during the select pulses for data electrodes of which associated pixels should not produce light, the data pulses occurring in-between the select pulses for data electrodes of which associated pixels should produce light.
